(19) United States
(12) Patent Application Publication
(10) Pub. No.: US 2003/0057043 A1
(43) Pub. Date: Mar. 27, 2003

(54) Transversely loadable composite of structural part and deformation element

(76) Inventors: Jan Hodgson, Neunkirchen-Seelscheid (DE); Carsten Kruse, Troisdorf (DE); Rolf Bruck, Bergisch Gladbach (DE)

Correspondence Address: LERNER AND GREENBERG, P.A., Post Office Box 2480, Hollywood, FL, 33022-2480, US

(21) Appl. No.: 10/215,455

(22) Filed: Aug. 9, 2002

Related U.S. Application Data
(63) Continuation of application No. PCT/EP01/01117, filed on Feb. 2, 2001.

(30) Foreign Application Priority Data
Feb. 9, 2000 (DE) 100 05 665.2

(51) Int. Cl. F16F 7/12

(52) U.S. Cl. 188/371

(57) ABSTRACT

A composite includes at least one structural part and a deformation element, in particular for the absorption of kinetic energy in the event of a crash of a motor vehicle. The deformation element can be deformed in a deformation direction to a residual block length. The deformation element includes a honeycomb-shaped matrix body. The matrix body and the structural part are connected to each other by an additional fastening, in such a way that the connection can resist forces transverse to the deformation direction.

### CROSS-REFERENCE TO RELATED APPLICATION

This application is a continuation of copending International Application No. PCT/EP01/01117, filed Feb. 2, 2001, which designated the United States and was not published in English.

### BACKGROUND OF THE INVENTION

### Field of the Invention

The present invention relates to a composite or system having at least one structural part and a deformation element that can be deformed up to a residual block length and has a honeycomb-shaped matrix body. Such deformation elements are used, in particular, for the absorption of kinetic energy in the case of a crash of a motor vehicle.

Deformation elements of that type are described, for example, in International Publication No. WO 99/57454, corresponding to allowed U.S. application Ser. No. 09/707,551, filed Nov. 7, 2000, International Publication No. WO 99/57455, corresponding to U.S. application Ser. No. 09/707,554, filed Nov. 7, 2000 and International Publication No. WO 99/57453, corresponding to allowed U.S. application Ser. No. 09/707,556, filed Nov. 7, 2000. Those deformation elements are used, in particular, in motor vehicles having a technical safety standard that requires the provision of appropriate elements which, for example, in the case of accidents, absorb at least part of the energies which occur and therefore reduce or even prevent deformation of the passenger compartment. If relatively severe impacts occur, the kinetic energy is converted into plastic deformation of the deformation elements. For example, deformation elements are known which are used in longitudinal members of a vehicle and which absorb the entire kinetic energy in the case of a crash at a speed of up to 15 km/h. The deformation elements are plastically deformed to a residual block length.

Deformation elements of that type are supported or held on one or both sides in structural parts in such a manner that the kinetic energy to be absorbed can be introduced substantially in a longitudinal direction of the deformation element, that is the deformation direction. The configuration of a deformation element with a honeycomb-shaped matrix body is very advantageous. The formation of the honeycomb-shaped matrix body with a predeterminable density, wherein the formation of a number of cavities is to be understood herein, and the use of different material thicknesses and material types for the matrix body, give rise to high structural flexibility with regard to obtaining a special dimensioning for such deformation elements. The dimensioning has a direct influence on the shaping of an appropriate deformation force/deformation path profile (F,s profile) which characterizes the deformation behavior of the deformation element when acted upon by force. That enables the matrix bodies to be adapted to particular applications.

The shaping of the deformation elements is carried out in principle in such a manner that with given component dimensions, a deformation path which is as long as possible is obtained and, in addition, simple installation or removal of the deformation elements is possible. Furthermore, that shaping of the respective honeycomb structure of the matrix body has a decisive influence on obtaining loading capacity properties which have to be ensured if deformation elements of that type are integrated or embedded in frame structures or supporting structures, in order to be able to compensate for any impact loads which may occur. Furthermore, the deformation behavior of the matrix body can be influenced by a suitable selection of material, the formation of channel walls and by special cutouts in the supporting structure.

Deformation elements of that type have a preferred deformation direction in which they absorb the kinetic energy, in particular. The matrix body of a deformation element of that type can be plastically deformed in the deformation direction up to a residual block length. The residual block length describes the state of the matrix body in which the material forming the matrix body is virtually completely folded up and squeezed together, so that hardly any cavities are still present, and a significantly increased amount of force is required in order to further deform or compress the matrix body. The deformation behavior is therefore substantially adapted to force being introduced or energy being absorbed in the deformation direction.

With regard to the preferred sphere of application of deformation elements of that type in motor vehicles having a particular technical safety standard, under some circumstances, for example in most accidents, impact is not just introduced in a predetermined deformation direction. It has to be ensured, particularly with collisions which do not take place exactly in the deformation direction and have a relatively small introduction of force, that the functionality of the deformation element is not afterward so severely impaired that the desired deformation behavior of the deformation element is no longer ensured in the case of a relatively major collision.

### SUMMARY OF THE INVENTION

It is accordingly an object of the invention to provide a transversely loadable composite or system of a structural part and a deformation element, which overcomes the hereinafore-mentioned disadvantages of the heretofore-known devices of this general type and which develops known deformation elements for motor vehicles to the effect that they also withstand considerable lateral actions of force.

With the foregoing and other objects in view there is provided, in accordance with the invention, a composite, in particular for the absorption of kinetic energy upon a crash of a motor vehicle, comprising at least one structural part and a deformation element being deformable to a residual block length in a deformation direction, the deformation element having a honeycomb-shaped matrix body. An additional fastening interconnects the matrix body and the at least one structural part for permitting the composite to withstand forces transverse to the deformation direction.

As mentioned above, the composite or system according to the invention which includes at least one structural part and a deformation element is used, in particular, for motor vehicles for the absorption of kinetic energy in the case of a crash. The deformation element has a honeycomb-shaped matrix body with a preferred deformation direction in which the latter can be deformed up to a residual block length during a crash. The composite according to the invention is distinguished in that the matrix body and the at least one structural part are connected to each other by a fastening in such a manner that this composite can withstand forces transversely with respect to the deformation direction. Forces transversely with respect to the deformation direction preferably or often occur if, for example, a collision of motor vehicles does not take place from the front.

A composite of this type including at least one structural part and a deformation element has a characteristic deformation force/deformation path profile (F,s profile). This is generally distinguished by a central region in which a force only insignificantly fluctuates about an average value during the deformation. This average value is used as a reference variable for the forces acting transversely with respect to the deformation direction and is referred to below as an average deformation force. The composite is advantageously constructed in such a manner that it withstands forces transversely with respect to the deformation direction. The magnitude of the forces corresponds at least to 10% of the average deformation force. The composite can preferably absorb at least 30%, in particular at least 50%, of the average deformation force transversely with respect to the deformation direction.

In accordance with another feature of the invention, the fastening is an adhesive. The end surface of the matrix body is bonded in this manner to the at least one structural part. The bonding of the matrix body and the structural part is particularly simple and of good value. The adhesive also has corresponding properties which permit use of the adhesive according to the sphere of use of the deformation element such as, for example, a predeterminable insensitivity to temperature and/or moisture.

In accordance with a further feature of the invention, the at least one structural part has a supporting ring. The supporting ring is used for holding the matrix body on the end surface. The matrix body is constructed, in particular, in such a manner that it is narrower than half of the residual block length of the matrix body. An undesired influence on the deformation behavior of the deformation element can therefore be prevented. The matrix body is bonded, at least at subregions of its jacket shell, to the supporting ring. The connecting region of the matrix body and the structural part has a more stable structure and therefore withstands a relatively great transverse load due to this supporting ring. This is assisted, in particular, if the matrix body is bonded at the end surface and the jacket shell to the structural part.

In accordance with an added feature of the invention, two of the structural parts and the matrix body are constructed with an anchoring channel. The two structural parts and the matrix body are disposed in such a manner that a continuous anchoring channel is formed. A tension rod advantageously extends through this anchoring channel. Through the use of the tension rod, a prestressing force can be introduced from the end surface into the matrix body disposed on the inside through the structural parts disposed on the outside. The tension rod has, for example, specially constructed screw connections for this purpose. Due to this prestressing force, the matrix body is connected frictionally to the structural parts and therefore enables forces to be absorbed transversely with respect to the deformation direction. A device of this type permits a very precise setting of the prestressing force, as a result of which the deformation behavior can be orientated to a given application in a simple and precise manner.

It is particularly advantageous to select the prestressing force in such a manner that a relatively uniform deformation behavior is ensured from the beginning of the introduction of the force until the residual block length is reached. Known deformation elements withstand a high initial force at the beginning of the introduction of kinetic energy, since the material forming the matrix body is aligned, for example, preferably in the deformation direction and the material therefore has to be initially compressed or folded, for which a relatively high force is required. Following such folding or compression, preferred deformation regions are formed, as a result of which the subsequent deformation takes place at a relatively low, relatively constant level of force.

In accordance with an additional feature of the invention, the large initial peak in the F,s profile can be avoided by setting the prestressing force produced by the anchoring shaft to be the same size as the difference between the maximum force of the initial peak and the average deformation force in the central region. Due to this prestressing, the deformation is initiated at a predeterminable and relatively constant level of force and only significantly increases when the residual block length is reached. When the tension rod is disposed in the deformation element, yielding possibilities which enable the tension rod to yield during deformation should be provided. As a result, the matrix body will preferably absorb the kinetic energy.

In accordance with yet another feature of the invention, the composite is constructed with at least one radial deformation restrictor. Radial deformation restrictors of this type restrict deformation of the matrix body in the radial direction or in a direction different from the deformation direction when kinetic energy is introduced into the deformation element. In this manner, the desired deformation properties are ensured without, for example, adjacent regions of the body being damaged.

In accordance with yet a further feature of the invention, the at least one radial deformation restrictor is a metal ring. The metal ring or metal rings together (including a possible supporting ring) have a smaller length in the deformation direction than the residual block length of the deformation element. This ensures that when the matrix body is completely deformed, the radial deformation restrictors do not exert a negative influence on the deformation behavior and therefore on the F,s profile.

In accordance with a concomitant feature of the invention, the composite is constructed with a matrix body which is bonded on the end surface to two structural parts and is surrounded by a plurality of radial deformation restrictors. One structural part is constructed with a supporting ring. The radial deformation restrictors are disposed uniformly and are distributed at a predetermined distance over the jacket shell of the matrix body. As a consequence of the matrix body being held on one side in a supporting ring, the connecting regions are constructed to be differently robust to transverse forces, as a result of which a defined predetermined breaking point is ensured in the case of the connecting point having the weaker structure. The behavior of the deformation element when overstressed can therefore be predetermined.

It is particularly advantageous to combine the composite according to the invention, including at least one structural part and a deformation element, with the features of International Publication No. WO 99/57454, corresponding to allowed U.S. application Ser. No. 09/707,551, filed Nov. 7, 2000, International Publication No. WO 99/57455, corresponding to U.S. application Ser. No. 09/707,554, filed Nov. 7, 2000 and International Publication No. WO 99/57453, corresponding to allowed U.S. application Ser. No. 09/707,556, filed Nov. 7, 2000.

Other features which are considered as characteristic for the invention are set forth in the appended claims.

Although the invention is illustrated and described herein as embodied in a transversely loadable composite of a structural part and a deformation element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, end-elevational view of a honeycomb-shaped matrix body;

FIG. 2 is a fragmentary, sectional view of an exemplary embodiment of a composite including a structural part and a deformation element;

FIG. 3 is a graph showing an F,s (force, distance) profile of a further deformation element; and

FIG. 4 is a view similar to FIG. 2 showing a basic configuration of a deformation element having two structural parts in accordance with a further embodiment of the invention.

### DESCRIPTION OF THE PREFERRED EMBODIMENTS

Referring now to the figures of the drawings in detail and first, particularly, to FIG. 1 thereof, there is seen a view of an end surface of a honeycomb-shaped matrix body 2. The honeycomb-shaped matrix body 2 is constructed from alternating sheet metal layers including corrugated metal sheets 12 and smooth metal sheets 13. The smooth metal sheets 13 substantially rest on corrugations of the corrugated metal sheets 12, with the result that a multiplicity of channels 11 are formed in the interior of the matrix body 2. The matrix body 2 is surrounded by a jacket shell or peripheral surface 4. As a result, a deformation element with a very compact structure is provided.

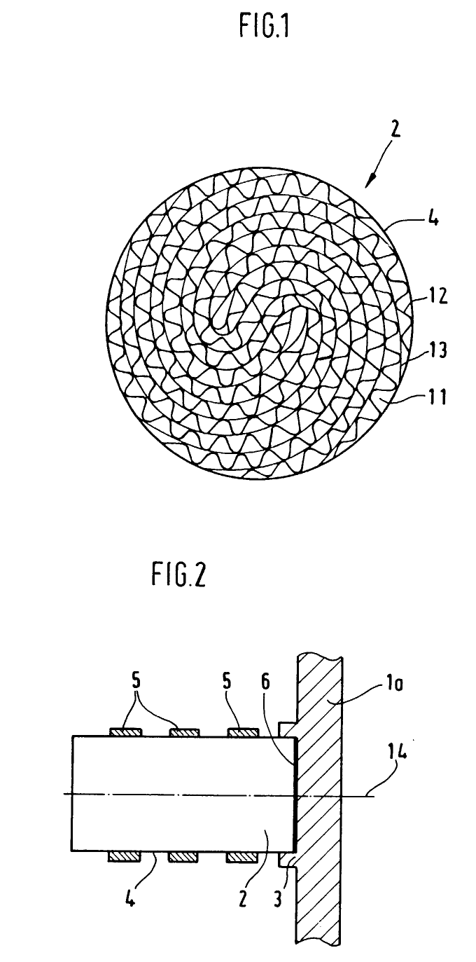

FIG. 2 illustrates a first exemplary embodiment of a composite or system including a structural part 1a and a matrix body 2. The structural part 1a has a supporting ring 3 which bears against the jacket shell 4 of the matrix body 2. The matrix body 2 is bonded or glued at an end surface 6 to the structural part 1a, providing an additional fastening. Three radial deformation restrictors 5 are disposed on the jacket shell 4 of the honeycomb-shaped matrix body 2. The radial deformation restrictors 5 are constructed as metal rings. A deformation direction 14 is illustrated by a dash-dot line. The structural part 1a can be disposed, for example, between a body or car body and a bumper or between the body or car body and a shock absorber.

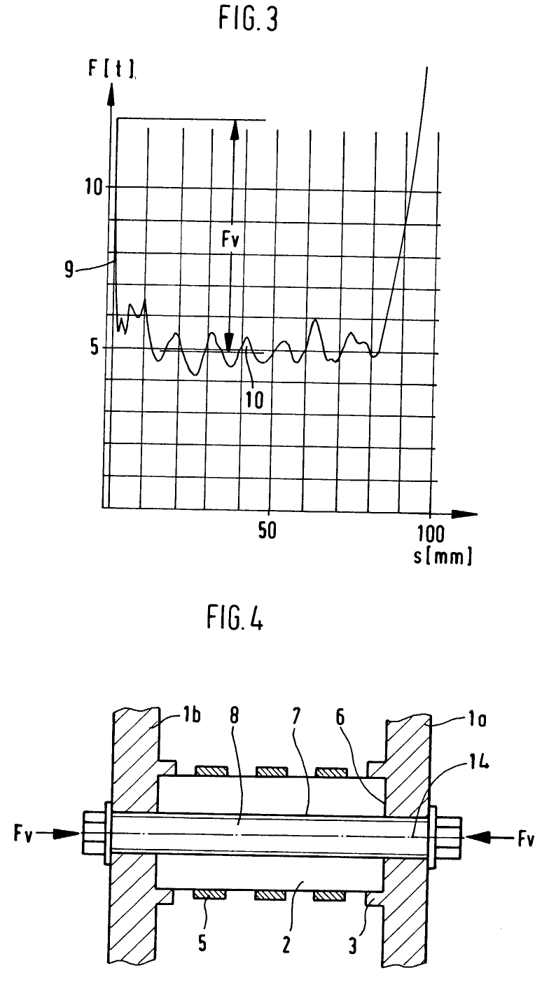

FIG. 3 shows, by way of example, an F,s (force in tons, distance in mm) profile of a known, tubular deformation element having a honeycomb-like matrix body made of metal which is disposed in a supporting structure. It can be seen from this diagram that at the beginning of an introduction of a corresponding kinetic energy into the deformation element, a high initial peak 9 of deformation forces occurs. This initial peak 9 is adjoined by a central region 10 in which the force merely fluctuates to a relatively small extent about an average value. When an end deformation state is reached, the deformation forces rise again. This means that when a compressive load on the deformation element further increases, hardly any more deformation occurs (a residual block length is reached). In FIG. 3, the difference between the maximum force during the initial peak 9 and an average force in the central region 10 is additionally illustrated with reference to a variable Fv. The deformation element is to be acted upon by this prestressing force Fv in the undeformed state if an initial peak 9 is not to occur at the beginning of deformation of these deformation elements.

FIG. 4 shows a further exemplary embodiment of the composite having two structural parts (1a, 1b) and a deformation element. Each of the end surfaces 6 of the honeycomb-shaped matrix body 2 is disposed in a respective supporting ring 3 of a structural part (1a, 1b). A plurality of radial deformation restrictors 5 are disposed on the jacket shell 4 of the matrix body 2. The two structural parts 1a and 1b and the honeycomb-shaped matrix body 2 are constructed with a continuous anchoring channel 7. A tension rod 8 extends through this anchoring channel 7. A prestressing force is introduced into the end surface 6 of the matrix body 2 through the structural parts 1a and 1b as a consequence of specially constructed screw connections at ends of the tension rod 8. This prestressing force is preferably selected in such a manner that an initial peak 9, as illustrated in FIG. 3, does not take place at the beginning of the introduction of the kinetic energy. Due to the prestressing, frictional forces acting counter to the transverse forces arise on the end surfaces 6 of the honeycomb body 2, when force acts transversely with respect to the deformation direction 14.

We claim:

1. A composite, comprising:
at least one structural part;
a deformation element being deformable to a residual block length in a deformation direction, said deformation element having a honeycomb-shaped matrix body; and
an additional fastening interconnecting said matrix body and said at least one structural part for permitting the composite to withstand forces transverse to the deformation direction.

2. The composite according to claim 1, wherein said fastening is an adhesive, and said matrix body has an end surface bonded to said at least one structural part.

3. The composite according to claim 1, wherein said at least one structural part has a supporting ring with an interior, said matrix body has an end surface and a jacket shell, said end surface is disposed in said interior of said supporting ring, and said jacket shell is at least partially bonded to said supporting ring.

4. The composite according to claim 1, wherein said at least one structural part is two structural parts, said matrix body has end surfaces, and said matrix body has at least one continuous anchoring channel and a tension rod extending through said anchoring channel for introducing a prestressing force into at least one of said end surfaces of said matrix body through said structural parts and frictionally connecting said matrix body to said structural parts.

5. The composite according to claim 4, wherein said deformation element has a deformation force/deformation path profile with an initial peak having a maximum force and a central region having an average deformation force, and said prestressing force is equal in magnitude to a difference between said maximum force and said average deformation force.

6. The composite according to claim 1, wherein said deformation element has at least one radial deformation restrictor.

7. The composite according to claim 6, wherein said at least one radial deformation restrictor is a metal ring.

8. The composite according to claim 1, wherein said at least one structural part is two structural parts, said matrix body has end surfaces bonded to said two structural parts, a plurality of radial deformation restrictors surrounds said matrix body, and one of said structural parts has a supporting ring for holding said matrix body.

9. A composite for the absorption of kinetic energy upon a crash of a motor vehicle, comprising:
at least one structural part;
a deformation element being deformable by the kinetic energy of the motor vehicle crash to a residual block length in a deformation direction, said deformation element having a honeycomb-shaped matrix body; and
an additional fastening interconnecting said matrix body and said at least one structural part for permitting the composite to withstand forces transverse to the deformation direction.
